(19) United States
(12) Patent Application Publication
(10) Pub. No.: US 2014/0154636 A1
(43) Pub. Date: Jun. 5, 2014

(54) METHOD AND APPARATUS FOR GENERATING GRAPHIC IMAGES WITH FIRE

(71) Applicant: Robert Thompson, New York City, NY (US)

(72) Inventor: Robert Thompson, New York City, NY (US)

(21) Appl. No.: 13/666,961

(22) Filed: Nov. 1, 2012

Related U.S. Application Data
(60) Provisional application No. 61/685,305, filed on Mar. 15, 2012.

(51) Int. Cl. F21V 37/00; F23D 3/16

(52) U.S. Cl. CPC F21V 37/00; F23D 3/16
USPC 431/126; 431/291

(57) ABSTRACT

A device for generating fire flame in the form of a pre-determined, two-dimensional graphic image is disclosed. The device has the general shape of a container and lid. A volume of combustible fuel is disposed within the container, and covered by a panel of flame-resistant material. The cover panel is perforated with holes arranged as a set of vector paths, which together for a graphic image. Wicking material is stitched along the perforated vector paths, and contacted with the fuel below, to created a candle-like apparatus for displaying images made up of curvilinear flame segments.

### FIELD OF THE INVENTION

This invention relates to candles.

### BACKGROUND

Common candles normally comprise a single wick, which is typically a segment of cotton string, running the entire depth, generally at the axis of the candle. For the sake of nomenclature here, the common wick can be said to be linear. That is, the cotton string has the shape of a [usually straight] line through the candle. We can say that the length of a common wick is roughly equal to the depth of its wax candle. So, for simplicity, we can also call the “length” of a wick, its “depth”.

### SUMMARY

Now, if one were to imagine a number of equal string segments (wicks) adjacently affixed together and embedded within the wax of a common candle in a contiguous array (side-by-side) so as to form a vertical plane, one would visualize a single planar wick. The term “planar wick” indicates that the wick itself takes the form of a surface. The surface may be curved along at least one direction. And, a planar wick need not necessarily be completely flat.

As the linear [common] wick exposes a “flame point” (when viewed from directly above), the planar wick exposes a “flame path” corresponding to the shape of the planar wick. When a planar wick is set afire, the flame it generates takes roughly the shape of the path it defines. A planar wick may define a path in the shape of a straight-line segment, or a curve segment. As one may see, the path could also be the shape of familiar graphic figures, lettering, and so on.

One of the main advantages of this invention involves the use of planar wicks, to form 2-D graphic images out of flame (when viewed from above).

### BRIEF DESCRIPTION OF THE DRAWINGS

FIG. 1-43 are various conventional views of several embodiments of the invention.

FIG. 44 is a top plan view of a new ornamental design for the invention, shown without its cover.

FIG. 45 is a perspective, exploded view of a new ornamental design for a candle container.

FIG. 46 is a perspective view with cover thereof.

FIG. 47 is a front elevation view with cover thereof.

FIG. 48 is a top plan view with cover thereof.

FIG. 49 is a bottom plan view thereof.

FIG. 50 is a right end elevation view with cover thereof.

FIG. 51 is a left end elevation view with cover thereof.

FIG. 52 is a rear elevation view thereof.

FIG. 53 is a front, exploded elevation view thereof.

### DETAILED DESCRIPTION OF THE INVENTION

This invention hereby incorporates-by-reference, and claims priority to two U.S. Provisional Patent Applications, having the USPTO Application Ser. Nos. 61/628,121 and 61/685,305.

The following description is presented to enable any person skilled in the art to make and use the invention. Various modifications to the disclosed embodiments will be readily apparent to those skilled in the art, and the general principles herein described maybe applied to other embodiments and applications without departing from the scope of the present invention. Reference to various embodiments and examples does not limit the scope of the invention.

Additionally any examples set forth in this specification are not intended to be limiting and merely set forth some of the many possible embodiments for the claimed invention. It is also understood that the techniques of the present invention may be implemented using a variety of methods or materials. For example, the methods described herein may be implemented using a variety of wicking materials including but not limited to glass, cotton, ceramic, or metal fibers, porous metals, porous ceramics, naturally occurring mineral rock with porous properties or combinations thereof. Such wicking materials may be implemented in conjunction with flammable fuels such as, but not limited to, liquid or solid state paraffin wax, alcohol, ethanol, bio-ethanol, methanol, kerosene, vegetable oil or various blends thereof.

The invention relates to an apparatus for creating fire-lit graphic patterns or images with a sewn wick. The invention also relates to a method for containing/routing a flame in a controlled path enabling the creation of intricate lighting effects and graphic designs with fire, as opposed to single point candle light created by conventional candles.

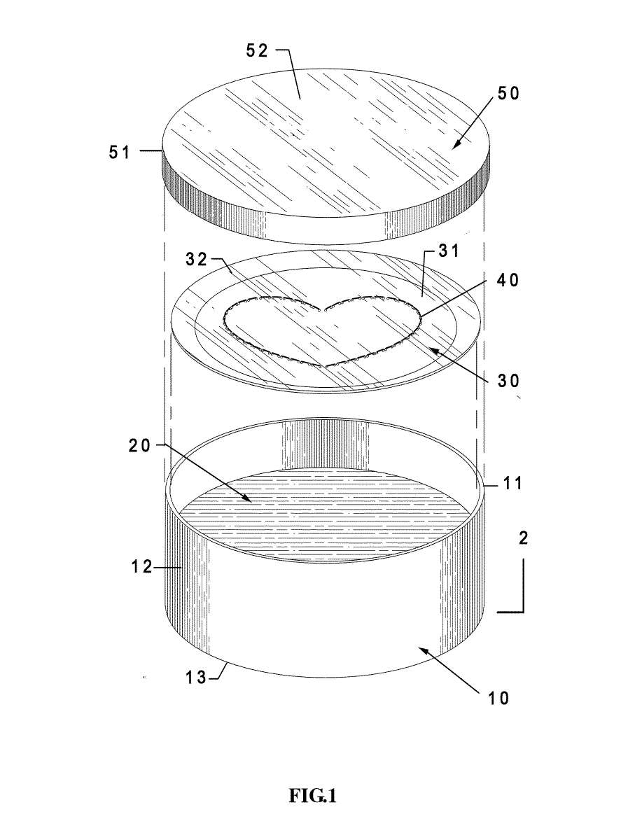

Accordingly, in one embodiment, the present invention provides a fire-lit graphic image comprising: a container 10; a combustible fuel 20 collected within the container cavity; a fire bed 30 floating on the surface of the combustible fuel; a stitched wicking body 40 of at least one stitch in length sewn into the fire bed plane; and a container cap 50 (as shown in FIG. 1—an exploded view).

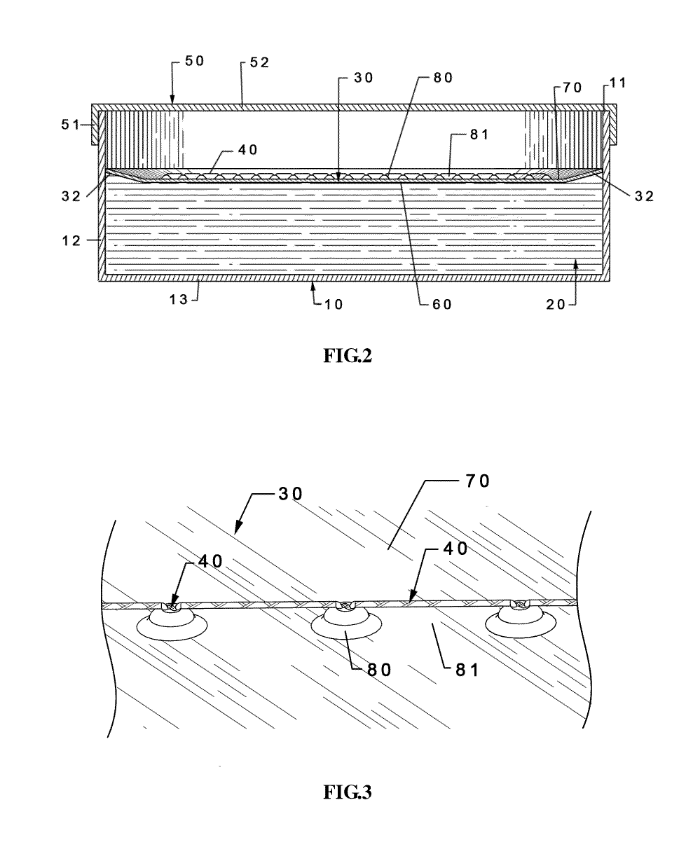

In further detail (as shown in FIG. 2—a cross sectional view), stitched wicking body 40 may be sewn into and through fire bed 30 creating an ignitable stitch, which may be repeated in a path. Each stitch segment may have a portion of its length extend downwards from a lower ply 60 of fire bed 30 remaining submerged into the underlying combustible fuel thereof, while having another portion emerge from an uppermost ply 70 of fire bed 30, which is exposed to the atmosphere.

The portions of stitched wicking body 40 exposed to the atmosphere may later be ignited to create and propagate the flame in a path, from stitch segment to stitch segment. In contrast with standard candles or torches, which generally employ a wick within a wax envelope, my invention is created by weaving the wicking portion into a plane so as to enable a fire-lit graphic image along the stitching.

Stitched wicking body 40 may comprise a number of juxtaposed, woven fibers or even a single porous fiber body stitched into a fire bed 30 in segments or combinations thereof as seen necessary to create a desired pathway, pattern or spelling of a word. Suitable wicking body materials may consist but not be limited to threading derived from mineral, organic materials or combinations thereof. Such material may also include glass, basalt, ceramic, alumina-based or metal fibers, as well ceramic paper stripping.

Other possible materials comprise phenolic resin enriched paper or cotton. High temperature threading derived from E glass or ceramic fiber or aramid is a common material used in many different areas of manufacturing which require high temperature resistance and provides a suitable stitch medium for the purposes intended.

Stitched wicking body 40 may be stitched into a pattern of predetermined size and shape. For instance, a sewn pattern might be that of a heart shape (FIG. 1). A pattern is constituted by at least one stitch, which defines a stitch segment. Larger patterns would ideally involve multiple stitch segments along a path. Suitable stitching types include but may not be limited to a running, basting, back stitch or combinations thereof. Stitch length and cross-sectional girth may be influenced to adjust the flame height per linear segment. Capillary action of the fibers exposed to the underlying combustible fuel layer would grant a continuous fuel supply for volatilizing the fuel when lit on the portion of the stitch exposed to the atmosphere, thus enabling a flame to form and expand from stitch to stitch along the wicking body length. The wicking material, being relatively resistant to combustion, would not burn away, but merely serve as a volatizing conduit for the fuel. As a result, any pattern formed may be ignited extinguished and re-ignited as long as deemed necessary to burn away the combustible medium reserve.

Flame height may be controlled through varying the length or girth of the single stitch unit. Flame height can also be controlled by altering the viscosity of the combustible fuel directly affecting the rate of flow of the fuel through the wicking fibers. Thus specific flame heights may be devised by adjusting either or both variables. It is desirable to produce a flame that is both containable and sustainable along the length of the stitch path, throughout the pattern. A suitable flame height for displaying graphic images without excessive flame distortion typically tends to be within a half inch in height, or less. Any flame height exceeding this value will tend to be uncontrollable and distort the image intended to be produced. Ideally, (as shown in FIG. 2), fire bed 30 would at least partially divide the reserve of combustible fuel 20 from the atmosphere, serving as a fire wall to prevent propagation of the flame from the stitched pattern onto the underlying fuel surface.

Ideally, however, fire bed 30 could be vessel shaped so as to remain buoyant upon the underlying combustible fuel surface through fluid displacement. Alternatively however, fire bed 30 may consist of a buoyant, closed-cell porous material. For instance, silicone, polycarbonate or phenolic resin foams, which display moderate temperature resistance may also prove suitable for short term applications. Fire bed 30 may comprise a number of shapes and configurations. Ideally, it would comprise a flat bed 31 portion surrounded, at least in part, by a lip 32 creating a platform floating on the combustible fuel surface by displacement (FIGS. 1 and 2). Alternatively (as shown in FIG. 6—a perspective view), the fire bed configuration may be shaped into a folded sheet arrangement so as to remain structurally self-supporting within a fuel filled basin.

Preferably, fire bed 30 would be made of a paper-thin sheet of heat-resistant material. Such materials may include, but not be limited to, metal sheeting, phenolic resin enriched sheeting or ceramic, glass or basalt fiber sheeting or even solid state heat resistant minerals such as marble, stone or other silica based materials.

Depending on the material employed, fire bed 30 may be manufactured in a number of ways. With sheet metal, the fire bed body and lipped edge may be cut and shaped in a single step, by means of a forming/cutting tool dropping over an anvil of the desired shape. Otherwise, it may be injection molded to the desired shape and thickness in a mold.

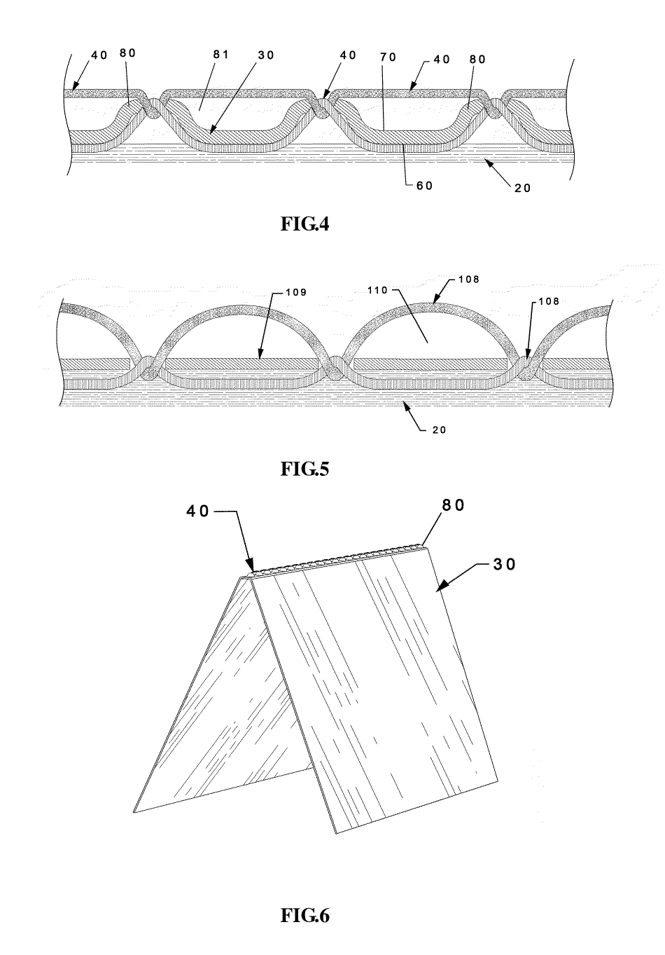

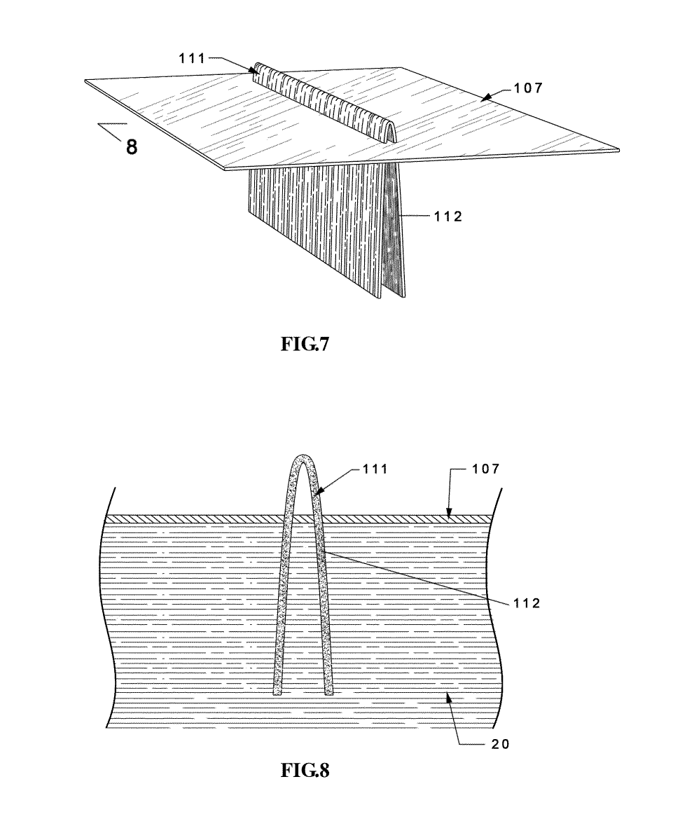

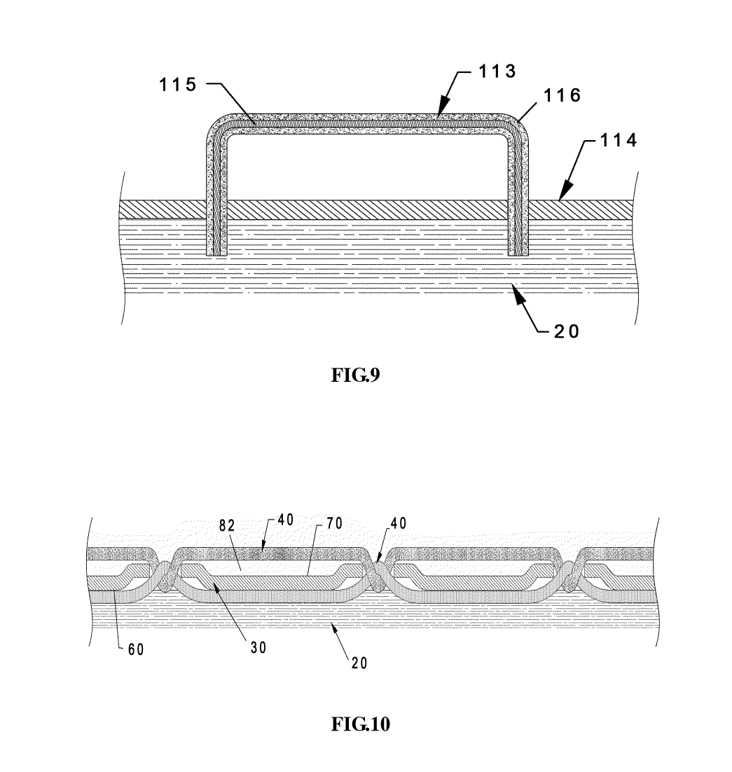

Fire bed 30 (as shown in FIG. 3—a perspective detailed view, and FIG. 4—a cross sectional view) may comprise portions of its surface embossed with surface deformations 80 localized at stitch segment suture points displacing at least a portion of the same from the underlying fire bed plane and creating an empty space 81 so as to facilitate air flow passage from either side below the stitch arch. Alternatively, air flow may be facilitated by a cavity 82 (as shown in FIG. 10—a cross sectional view) formed by indenting portions of the fire bed plane under or between each suture.

Displacement between stitching segments and the fire bed plane may be needed in sewn, closed loop paths to allow air flow passage from the outer periphery of the loop to its center. By experimentation it was found that, when a continuous flame burns in a closed loop arrangement, the resulting flame tends to deprive the oxygen from the center of the loop, creating a sort of vacuum effect, deforming the upward trajectory of the flame wall into a cone shape. As a result the looped arrangement becomes visually distorted. Allowing a constant supply of oxygen flow to the loop center via air passageways created by the stitch displacement minimizes the vacuum effect encouraging a generally vertical and undistorted fire wall formation all around the loop perimeter. A particularly suitable surface deformation contour, regardless of it upward or downward orientation would be that of a cone or dome, given the inherent all around symmetry (FIG. 3).

Stitched wicking body 40 may be sewn into fire bed 30 by means of industrial sewing or embroidery machines possessing a programmable software program capable of generating intricate sewing patterns onto a flat plane using diverse threading and fire bed materials. Industrial embroidery and sewing machines possess the necessary force and accuracy as well as component durability to both perforate a paper-thin fire bed material and create stitching points with ease and speed, resulting in a cost-effective process. Furthermore, this method of fabrication enables anyone, skilled in the art, to generate a number of customized patterns in different sizes in a relatively inexpensive manner, without complicated steps or excessive lag time between diverse pattern creations.

Although surface deformations 80 or cavities 82 could be formed in situ and at the same time as the wicking body thread is sewn into the fire bed plane via modifications of sewing machine assembly components, a simplified method would be to separate the processes forming the deformations of a specific pattern onto the fire bed plane first, then proceed with sewing process. This may be achieved in a variety of ways, however a simple process might involve an embossing machine with pre-programmed patterns reflecting that which the sewing process will later trace aligning each stitch segment suture point with its designated surface deformation.

By experimentation, a minimum gap width between 1 to 3 millimeters is recommended between the fire bed plane and the stitch segment axis in order to avoid unwanted accidental clogging of the air passageway with excess combustible fuel deposits or dust particles. Container 10 forms an open ended cavity which results from the joining of a container wall 12 with a container bottom 13 (FIGS. 1 and 2). Container cap 50 encloses the cavity of container 10 from the outside environment when not in use. Cap 50 may be take form as a number of different shapes, however a preferred embodiment would comprise a cap body 52 surrounded by a cap rim 51 fashioned to create a relatively air-tight seal with an open edge 11 of container 10 along container wall 12 (FIGS. 1 and 2). Cap 50 may be also be used as a means to extinguish the flame of a lit pattern within the cavity of container 10 by oxygen deprivation. Cap 50 and container 10 may be conceived of a number of materials, but of particular preference are those suitable in situations with elevated temperatures. It is known in the field that the use of temperature resistant materials such as polycarbonate, glass, ceramic or metal are acceptable for the construction of fire containing envelopes. A sheet metal derived cap 50 and container 10 may be formed by a process of metal stamping and drawing or, alternatively, it may be derived from injection molding of a thermoplastic. Any number of shapes may be employed in the fabrication of the container, cap and the fire bed profile without compromising the functionality of the assembly.

In another embodiment of the present invention, a wicking body 108 may be stitched to a fire bed 109 in a loose format causing the stitch body to arc upwards between stitch points and generate arched air passage vents 110 (FIG. 5—a cross sectional view). Stitched wicking body 40 could have any number of cross sectional shapes as well as express various ratios of stitch width-to-length. For instance, a widened stitch segment 111 may express a greater width than length (FIG. 7—a perspective view, and 8—a cross sectional view) possibly under the form of a flexible wicking plane 112 stitched into and through a fire bed plane 107. This specific embodiment may be useful in generating elongated straight wicking paths without interruption.

In another embodiment, the pattern may consist of isolated wicking segments 113 of a rigid or semi-rigid nature possessing a staple-like shaped body having a metal core lining 115 and a threaded outer fiber sheathing 116 (FIG. 9—a cross sectional view). Wicking segments 113 could be individually stitched into a fire bed plane 114 by a disjointed sewing process or a stapling process along a path. Lining 115 may be comprised of, but not limited to, a heat resistant wire having rigid or semi-rigid properties such as those expressed in a number of metal alloys. Fiber sheathing 116 could be made by weaving a glass fiber into a tubular fashion enveloping core lining 115 within its hollow core. Wicking segments 113 may be made much like the process of fabricating standard staples with the addition of an extra process in which a woven fiber sheath is applied to the outer staple body.

For this embodiment, a wire lining is fed from coils into machines which provide a continuous feed of the wire into and through a woven fiber sheath. In a second step, the sheathed wire is run into a forming tool which cuts each staple segment to a length as a forming-cutting tool drops over an anvil, forming the shape of the single sheathed staple at once. Each staple is then moved along a sliding rail through a sprayer where a wax coating is applied to the outer surface before it is pushed together into a line formation. Segments could then be applied to a fire bed body by means of a stapling mechanism either by hand or by programmable automation process. Alternatively, it may be sewn into the fire bed plane in a disjointed sewing process. Metal cored sewing threads are known to be used in industrial applications requiring high tensile forces.

Accordingly, in another aspect, the present invention provides a fire lit graphic image comprising: a container 210; a combustible fuel 220 collected within the container cavity and a wicking body strip 240 (FIG. 11—an exploded perspective view). Container 210 may comprise a base ply 211 and a perimeter wall 212. Container 210 may formed by drawn aluminum stamping in similar way as those currently used for the container construction of tea light candles.

Wicking body strip 240 may express of a number of embodiments. Although each embodiment may possess certain advantages over others, combinations of the same maybe employed under the scope of this invention.

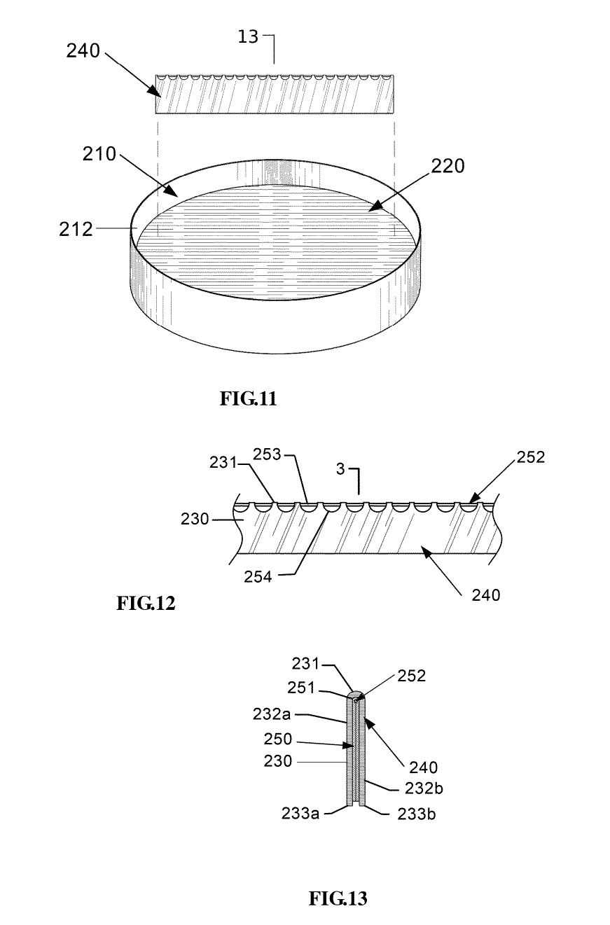

In a preferred embodiment, wicking body strip 240 may comprise a support wall 230 of generally vertical arrangement, formed by folding a heat-resistant sheeting material, comprising an upper creased edge 231 and a pair of lateral walls 232a and 232b ending in open-ended lower edges 233a and 233b. Sandwiched within the inner plies of lateral walls 232a and 232b, (as shown in FIG. 13—a cross sectional view) may lie a folded, porous lining 250, in turn housing a wicking thread filament 252 within and along the inner plies of a liner creased edge 251 for a predetermined, overall length of wicking body strip 240. Coincidental portions may be removed from upper creased edge 231 and creased edge 251 (as shown in FIG. 12—a side view) at selected intervals forming a series of cutaway profiles 254 and exposing ignitable sections 253 of thread filament 252 to the outside atmosphere, thus forming intermittent, ignitable wick portions along upper creased edge 231 in a vector path.

When fire is applied to an exposed ignitable section 253, it catches fire and propagates a flame to the next adjacent section eventually forming a line of fire along the wicking body length. Cutaway profiles 254 may vary in shape, span or depth. Through experimentation, it was found that longer cutouts would expose more wick length to volatize wicked fuel resulting in a higher flame vector height and vice versa. Cutaway profiles 254 may also vary in frequency and spacing per unit length. Generally, the higher the frequency of ignitable segments per unit length, the quicker the flame propagation from one exposed wick portion to the next and vice versa. Beyond a certain profile interval distance, however, it was found that the flame would not propagate and the resulting flame vector would appear segmented or dotted. As ignitable segment 253 characteristics can be predefined, one is consequently able to control the flame vector characteristics over an undefined length with consistency. It was also found that arching ignitable sections 253 (FIG. 14—a side view) to form arched wick sections 253a also promoted propagation and flame height whereby increasing exposed wick length and volume per unit distance. Ignited wick sections 253 form and propagate a flame in vector fashion following a predetermined vector or direction. In contrast to standard candles or torches which generally employ a vertical wick submerged within a wax pool to achieve a single point flame when lit, my invention allows the formation of a flame vector which can be directed in a multitude of vector paths and lengths, the result of which enabling one skilled in the art to create a graphic image with fire.

Portions of thread filament 252 and porous lining 250 which remain sandwiched within the inner plies of support wall 230 remain relatively unexposed to the outside environment and void of oxygen supply, thus will not combust even at otherwise volatizing temperatures consequently allowing an upward wicking effect to supply combustible fuel for volatilization.

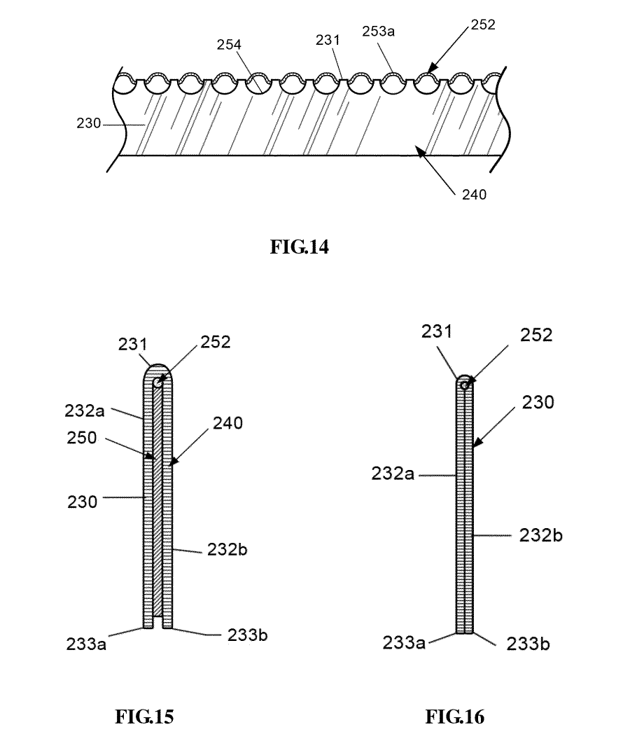

Depending on the density and flammability characteristics of the combustible fuel used, variations to cross sectional volume of porous lining 250 may be useful. For instance, it has been found through experimentation when using less dense combustible fuels or fuels in liquid form at room temperatures such as alcohol, ethanol or fuels with relatively similar viscosities and volatility, the resulting capillary action, and thus wicking flow is more efficient, allowing porous lining 250 to be reduced to a single sandwiched ply of lesser volume (FIG. 15—a cross sectional view). Furthermore, if the separation between lateral walls 232a and 232b is sufficiently small, (as shown in FIG. 16—a cross sectional view), capillary action may be created by their proximity alone and may provide adequate wicking continuity to thread filament 252 thus omitting the need for lining all together.

Other experimentations have proven that, with the adoption of low viscosity combustible fuels, an alternative embodiment of wicking body strip 240 (as seen in FIG. 17—a side view) may omit the need for thread filament 52 in which porous lining 50 itself may act as the ignitable portion if left exposed.

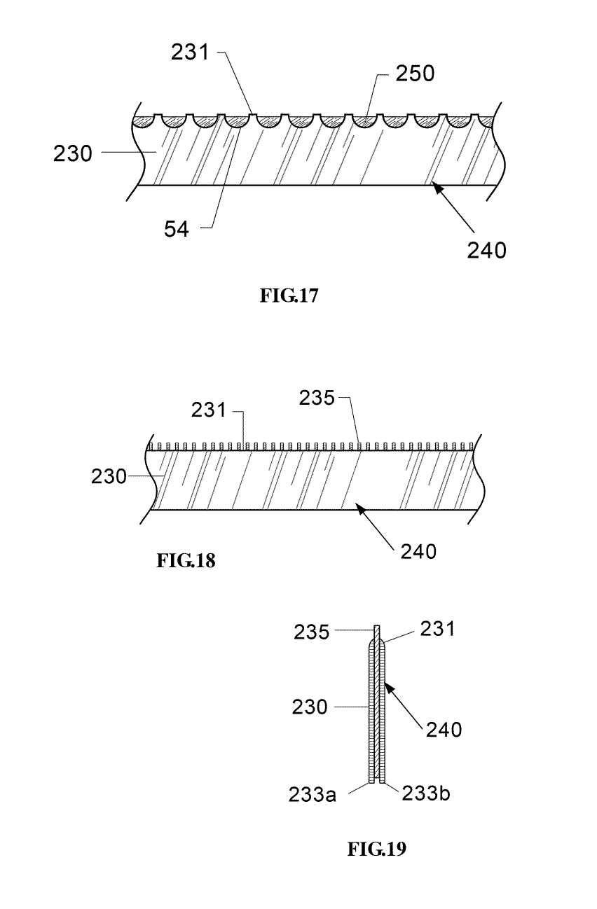

Another embodiment yet for wicking body strip 240 (as shown in FIG. 18—a side view) comprises of a number of open-ended wicks 235 piercing through upper creased edge 231 and spaced from one another in a row. Open-ended wicks 235 may be formed by a generally circular or flattened cross section having a lower portion sandwiched within the inner confines of support wall 230 (FIG. 19 a cross sectional view). In this embodiment flame height and propagation speed is regulated via the height of the exposed wick ends and their relative spacing respectively.

Support wall 230 may be made of a heat resistant material with the ability to flex. Although there are a number of materials with these characteristics, a particularly suitable one is aluminum for its innate heat conduction. Other metals comprising alloys of steel or copper may also be suitable as well as heat resistant composites, thermo-set polymers or phenolic based impregnated composites.

Ideally, thread filament 252 may be comprised of weaved fibers or even a single porous fiber body with malleable characteristics. Suitable materials may consist of, but not be limited to, threading derived from mineral, organic materials or combinations thereof. Such spectrum may include glass, basalt, ceramic, alumina or metal based fibers as well as ceramic paper stripping. Other possible materials comprise enriched paper or cotton. High temperature threading derived from E glass or ceramic fiber is a common material used in many different areas of manufacturing which require high temperature resistance and provides both a suitable wicking and ignitable medium for the purposes intended. Through experimentation, it has been found that ceramic or para-aramid based enriched threading, both of which typically used for sewing garments for high heat applications, worked well for prolonged periods of ignition. Furthermore, both materials have proven suitable in the process of repeated extinguishing and re-lighting which is a desirable trait in candle usage. These materials also have proven to be stable at high temperatures with minimal charring and filament consumption. Additional features for these material choices are their high tensile strength and resistance to pre-tensile stresses which could destabilize the wicking ability of the material or alter their wicking flow rate. The threading material used, being relatively resistant to combustion, may not burn away but serve as a volatizing conduit for the fuel. As a result, any pattern formed may be ignited, extinguished and then re-ignited several times over as deemed desire-able until the combustible medium supply is consumed. Upon complete consumption of the combustible fuel, wicking body strip 240 may self extinguish.

Cotton cloth or paper have proven to be suitable wicking materials for porous lining 250. As this portion does not typically combust due to its oxygen deprived state, it is able to retain its porous integrity over time.

Wicking body strip 240 may be left unbent to form a straight line or bent upon its vertical axis to form an indefinite range of curved pathways into an outline of a desired graphic image.

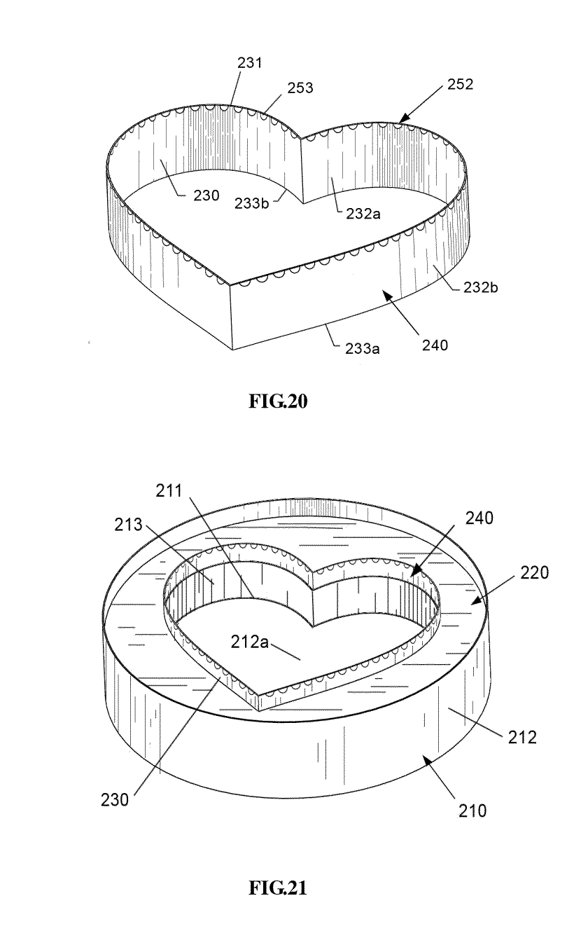

A number of strips may conjoin or intersect with each other to diverge, converge or fork in a multitude of angular degrees forming other shapes or even inner details of a larger graphic image. Strips may also be bent into partial or fully enclosed loops, spirals or a zigzag patterns. An number of shapes may be formed using this method, for instance that a heart shape may be formed this way (FIG. 20—a perspective view).

Designs may be achieved combining several wicking body strips in connected or disconnected arrangements with intersecting portions or by using a single wicking body strip bent in a multitude of directions.

Ideally, wicking body strip 240 would be at least partially submerged into combustible fuel 220 so that a portion of the heat generated by the flame would be absorbed by the surrounding fuel either by radiation or conductive heat propagation. When using waxes or dense oils as fuels, for instance, heat may conduct down the wicking body structure melting the surrounding wax to form a pool enabling capillary action to occur and feed the fuel volatilization process. It has been found that a support wall 230 structure derived from aluminum foil construction is particularly suitable for such a process given the materials' favorable coefficient of heat conduction. The folded sheet arrangement of support wall 230 enables the strip to remain structurally rigid and self-supporting and can therefore be placed within a basin without additional supporting means.

It has been found by experimentation that, when forming either a semi or fully looped enclosure between one or more wicking strips, air flow becomes necessary within the inner void space when ignited into a flame vector in order to prevent the resulting fire vector from growing into a fire cone. Fire cones are not typically desired as they may distort the underlying image and provide unwanted smoke during volatilization. To compensate for this, container 210 may comprise one or more secondary tunneling cavities 212a which may allow air passage through open, medial portions of base ply 11 in areas where enclosed or semi-enclosed flame vector patterns are necessary for the design. Tunneling cavities 212a may be formed by cutting out sections of base ply 211 and surrounding said sections by an enclosed cavity wall 213 which, in turn, may be fixed to base ply 211 using a heat resistant adhesive or a pressed fitting granting a water-tight seal all around (FIG. 21 a perspective view). Fuel is allowed to surround the hollow cavity openings without leakage. Tunneling cavities 212a may vary in size, number, shape and position depending on the image created, thus container 210 may require a customized fabrication process to suit flame vector designs. Flame vector designs which form neither looped nor semi-looped arrangements such as those found in shallow arcs, zigzag patterns, parallel lines or crossed configurations may not require air cavities and can therefore adopt a standard single cavity container. Typically it is found that the best air flow results are achieved when the aperture size and shape resembles that of the surrounding flame vector. Wicking body strips 240 may be laid to rest upon base ply 211 without fixation or may be affixed directly to portions of cavity wall 213 by means of mechanical fixtures or heat resistant glue.

Container 210 and tunneling cavities 212a may be fabricated by a combined process of drawn metal stamping and gluing. Wicking body strip 240 may be fabricated in a number of ways depending on the above mentioned embodiment design. One method may involve extruding and cutting aluminum foil into a long or continuous strip followed by a process of creasing and folding down a midline. Porous lining 250 is inserted within the fold and cutaway profiles 254 are punched out from the folded edge followed by the insertion of thread filament 252 then squeezing together for sealing. Sections of different lengths can then be cut and folded at the ends to remove air access from the outside to the enclosed areas within. Strips may then be bent to a desired shape and placed within the container. Strips may be fastened to each other at varying angles using stitching, glue or mechanical fasteners. Similarly, strips may be fastened to base ply 211 or laid to rest freely within the container cavity. This fabrication process may require a manual or automated bending and placement process. In a final step, a fuel such as a wax may be poured into the container at least partially submerging the strips and is let to solidify.

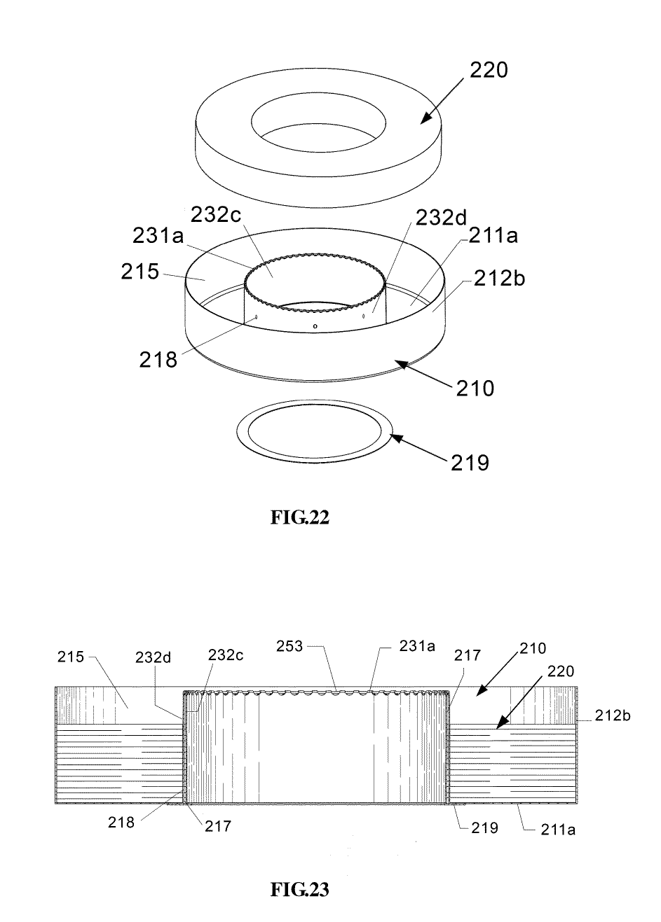

A simplified version of my invention combines container 210 and wicking body strip 240 into a single molded component (FIG. 22 an exploded perspective view). In this embodiment container 210 and wicking body strip 240 are formed from a single sheet of heat-resistant material, simultaneously, by a process of drawn metal stamping.

During this process several portions are created in one step including an inner lateral wall 232c, an outer lateral wall 232d, an upper creased edge 231a and a outer container wall 212b being molded directly from a common base ply 211a as upwardly drawn and stamped out deformations of the same. During the drawn stamping phase, an external reservoir cavity 215 is formed on the outer band of the component, and a wicking fissure 217 is formed within the internal plies of inner and outer lateral walls 232c and 232d (FIG. 23—an elevation cross sectional view). A number of fueling holes 218 may perforate, through and through, lower edge portions of outer lateral wall 232d in selected areas providing conduits for fuel to migrate from container reservoir 215 into wicking fissure 217 as capillary action created by the same draws fuel up towards ignitable segments 253 lining upper creased edge 231a. A seal 219, bearing a cut out shape comparable to that of the flame vector design desired may be adhered to the bottom face of base ply 211a on the underside the molded component to seal off the open, lower end of wicking fissure 217 and prevent fuel from leaking therefrom.

Air flow passage locations may be created, by puncturing, through and through, selected areas of base ply 211a and seal 219 as needed (FIG. 23). Aside from advantages in manufacturing and assembly processes this embodiment and method of fabrication may allow a greater degree of freedom and precision while generating complex patterns of smaller size.

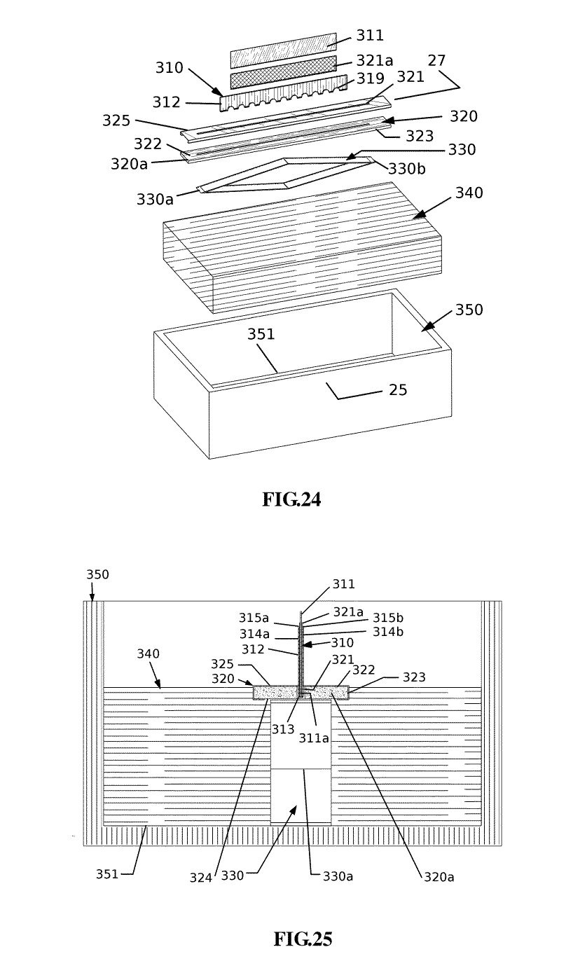

Accordingly, in another embodiment, (as shown in FIG. 24—a perspective exploded view) the present invention provides one or more planar wick segments 310 supported by a floating platform 320 linked to a flexible anchoring spring 330 within a combustible fuel 340 and collected within a container 350.

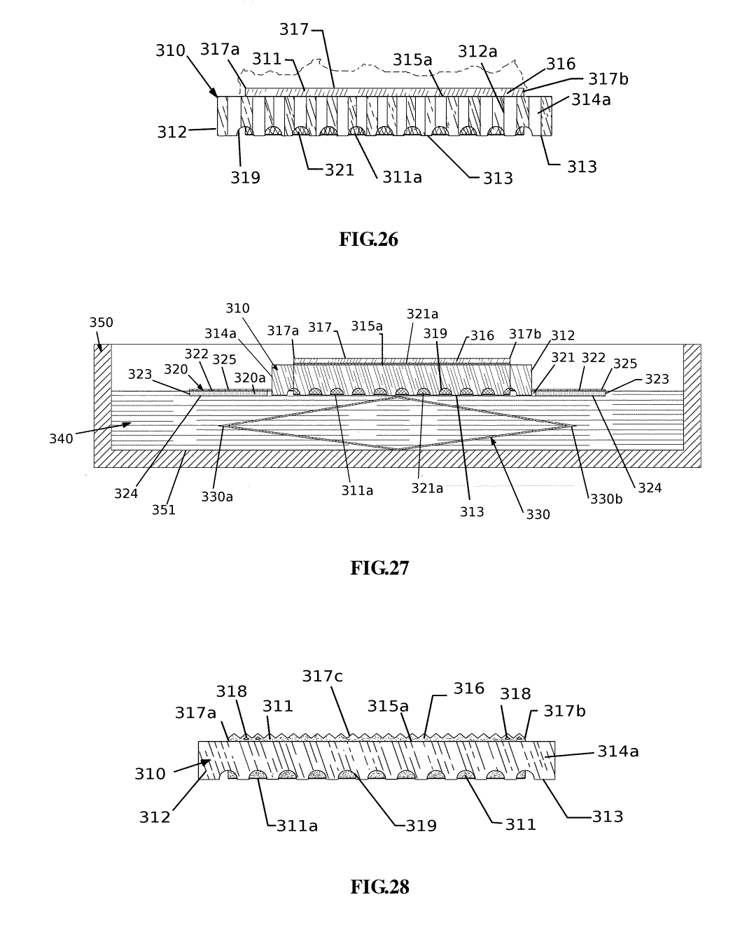

In a preferred embodiment, planar wick segment 310 may comprise an inner wick body fabric 311 (as shown in FIG. 25—an end cross-sectional view) sandwiched within a containment wall barrier 312 formed by folding a heat-resistant sheeting material, comprising an lower creased edge 313 and a pair of lateral walls 314a and 314b ending in open-ended upper edges 315a and 315b (best seen in FIG. 25). An uppermost ignitable edge 317 (as shown in FIG. 26—a front elevation view) of wick body fabric 311 is left uncovered by wall barrier 312 exposing an ignitable tongue 316 while a lower wick edge 311a (FIG. 25) remains sandwiched within lower creased edge 313. Two lateral edges 317a and 317b of tongue 316 are left exposed offering favorable locations to light ignitable edge 317 with fire.

It was found by experimentation that flame height resulting from the ignition of tongue 316 can be controlled by varying the height of the strip exposed as well as varying its cross-sectional thickness. For instance, a range of 1 mm to 2 mm in height, proved to provide an easily ignitable wick with a fairly smoke-free burn with most fuels, while an overall fabric thickness of 0.5 mm to 1 mm proved to be sufficient for proper capillary action even over prolonged periods of ignition and after a layer of carbon build up.

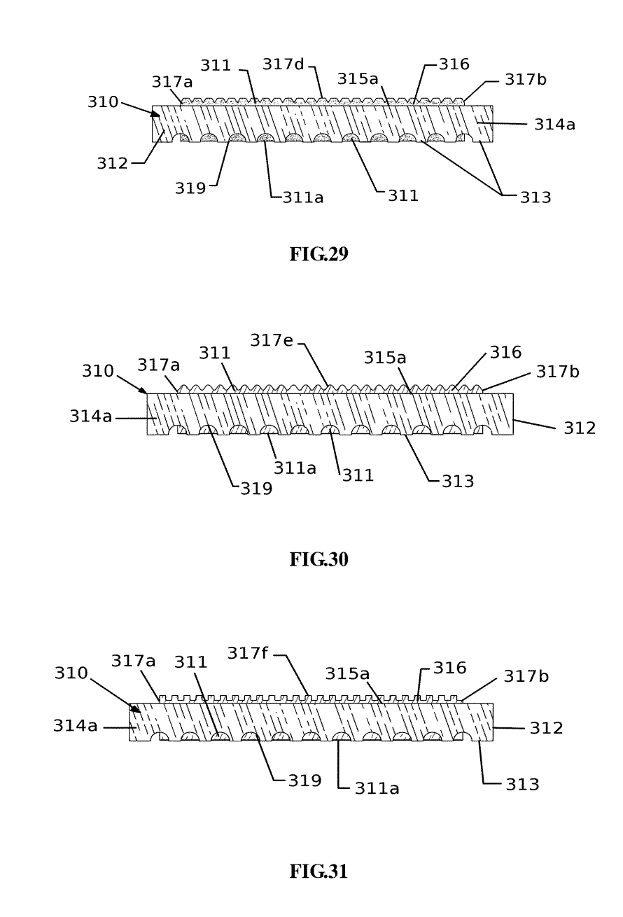

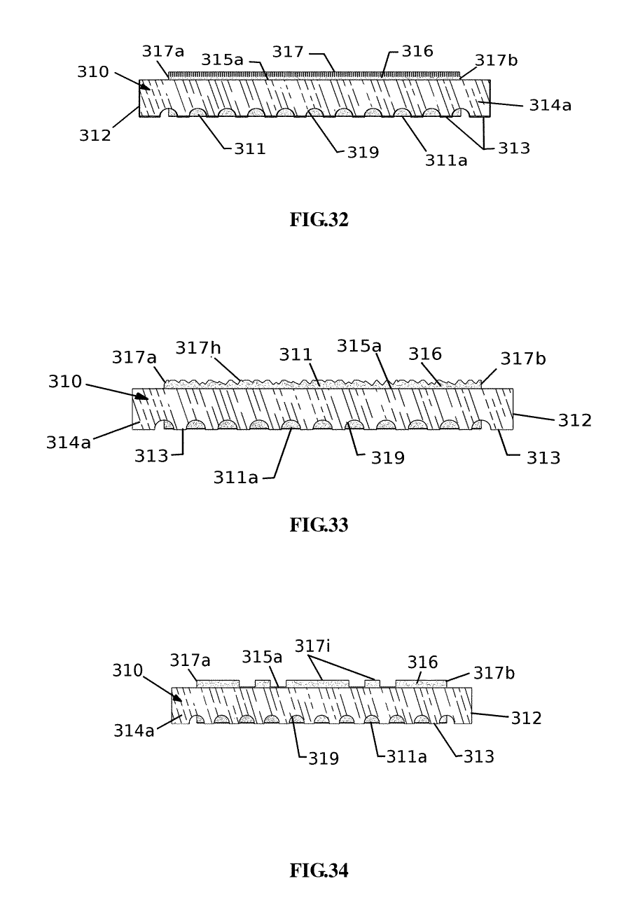

Sandwiched between the outer plies of wick body fabric 311 and the inner plies of lateral walls 314a and 314b (as shown in FIG. 25 and FIG. 26) may reside a mesh filter sheet 321a lining the inner wall portion of containment wall barrier 312 possibly extending upwards to line a portion of the lateral plies of tongue 316 acting both as a particulate filter and thermal isolator between the sandwiching layers. Sections of lower creased edge 313 (as shown in FIG. 26) may comprise a number of perforations 319 spaced at intervals, exposing portions of lower wick edge 311a and mesh filter ply 321. As planar wick segment 310 is intended to partially submerge into a fuel, the exposed portions would provide entry points for fuel to enter the sandwiched structure and ascend the inner layers by capillarity. Although ignitable edge 317 may comprise a generally straight cut edge (best seen in FIG. 26), non linear edges have proven to be more resistant to carbon buildup and easier to re-ignite subsequent times. For instance, tongue 316 may embody a triangular 317c serrated edge (shown in FIG. 28), trapezoidal 317d (shown in FIG. 29), wavy 317e (shown in FIG. 30), quadrangular 317f (shown in FIG. 31), frayed 317g (shown in FIG. 32), random 317h (shown in FIG. 33), or combinations thereof. It was also found that the ignition speed and resistance to carbon buildup may also be increased by introducing one or more inner body perforations 318 (as shown in FIG. 28) of varying shapes along the exposed tongue 316 height, enhancing the “light-ability” of the wick inducing oxygenation within the ignitable material.

Furthermore, one or more sections of uppermost ignitable edge 317 (as shown in FIG. 34) may be selectively cut away to form isolated lighting segments 317i of variable length. In this way, one may achieve different line types including a dotted, a dashed line or combinations thereof. Wick body fabric 311 may consist of a sheet of matted fibers, a woven cloth or even a single porous fiber body with malleable characteristics. Suitable materials may consist of, but not be limited to, matting derived from mineral, organic materials or combinations thereof. Such materials may also include glass, basalt, ceramic, alumina or metal based fibers as well as ceramic paper matting. Other possible materials comprise enriched paper or cotton. High temperature fabric derived from E glass or ceramic fiber are also common materials used in many different areas of manufacturing that require high temperature resistance and thus provide suitable mediums for the purposes intended. Other possible materials include porous metals or minerals.

Planar wick segments 310 may be cut into segments of varying lengths and left unbent to form a generally straight line or bent upon a vertical axis to form a curved path. A graphic image or portion of a larger graphic outline may be constructed as a result of a single segment bent in numerous planar directions or by conjoining a number of smaller, bent wick segments and intersecting them with each other to diverge, converge or fork in a multitude of angular degrees. Strips may also be bent into partial or fully looped planar paths, into spirals, zigzag patterns or combinations of the same. Any number of graphic outlines may be created using this method. Portions of containment wall barrier 312, (as shown in FIG. 26) and layers sandwiched within, may be pressed into a pleated or corrugated texture 312a of generally vertical orientation. The pleated texture provides a weakening of the containment wall barrier fold, adding superior lateral flexibility to the strip as well as a mechanical binding between the sandwiched layers preventing them from shifting and separating from one another as portions of the segments are bent.

Containment wall barrier 312 may be formed by sheet metal stamping while wick body fabric 311 may be formed by a fabric sheet stamping. Planar wick segments 310 may be constructed by the folding of wall barrier 312 over wick body fabric 311 sandwiching it within, followed by a surface pleating process.

Floating platform 320 (as shown in FIG. 24 and FIG. 25) ideally comprises a buoyant body having an upper ply 322 an outer lateral edge 323 and a lower ply 324 and one or more mounting fissures 321 scoring and piercing through the cross-sectional thickness of floating platform 320 in a predefined pattern or path. Floating platform 320 would ideally remain afloat upon the combustible fuel surface within container 350, with upper ply 322 facing upwards and lower ply 324, lateral edge 323 and fissure 321 generally submerged within the underlying combustible fuel surface.

Depending on the path desired, fissure 321 may form a straight cut or (as shown in FIG. 24), a curved, serrated, or irregular cut path depending on the intended design wanted. One or more planar wick segments 310 may be inserted into corresponding fissure openings of the platform as they are held in place, in a buoyant yet partially submerged fashion within the combustible fuel surface accumulated within the void of fissure 321. When using saturated waxes or oils as fuels, for instance, a portion of the heat generated by the flame during ignition of the wick segment strip is absorbed by the surrounding fuel through radiant or conductive heat propagated through the sandwiched layers, melting the surrounding fuel to form a liquid pool and ultimately enabling capillary action to feed the fuel volatilization process through perforations 19. The folded sheet arrangement of containment wall barrier 312 enables the wick to remain structurally rigid and erect as it is held into the desired path by fissure 321.

In a preferred embodiment, floating platform 320 (as shown in FIG. 25) may comprise a stamped out, low density core body 320a lined by a heat resistant foil laminate 325 cut to size. Materials having low densities for flotation may include, but not be limited to, closed cell foams, balsa wood, cork or synthetic foam amalgamates. Foil laminate 325 may serve both as a thermal barrier to prevent accidental charring of underlying core body 320a as well as a serve as a thermal conduit for diverge and conduct residual radiant heat into the surrounding fuel when the wick is lit. Foil laminate 325 (as shown in FIG. 27—a front cross sectional view) may be glued or mechanically affixed to floating platform 320 by stapling, riveting or surface crimping. Floating platform 320 is linked to a base ply 351 of container 350, with restricted motion, by anchoring spring 330 (as shown in FIG. 24) comprising a flexible laminate leaf spring structure of generally constant width and cross sectional thickness, folded into a looped arrangement and creased on two opposing ends 330a and 330b. Anchoring spring 330 allows floating platform 320 to remain generally level with the fuel surface while at the same time limiting its horizontal displacement within the container void. Anchoring spring 330 may be constructed from a paper or fabric, or heat resistant plastic, cut into a strip and folded, and may affix to base ply 351 of container 350 and lower ply 324 using a heat resistant glue or a staple, preferably along a mid line or center axis of the same. As combustible fuel 340 lowers, being consumed by volatilization, anchoring spring 330 gradually collapses eventually remaining fully collapsed under the weight of floating platform 320 when the fuel is finally exhausted.

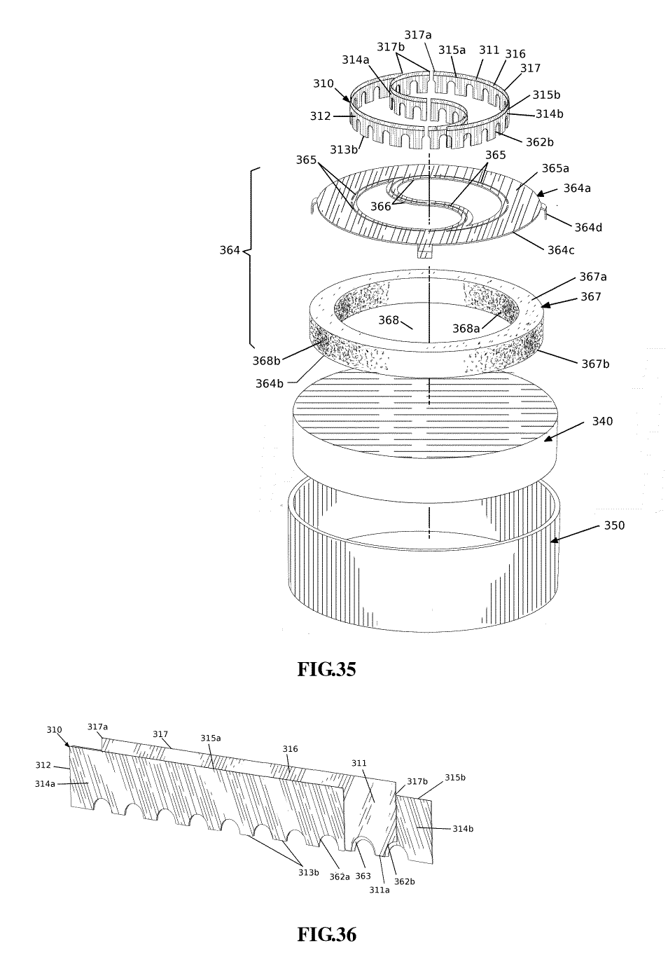

In an alternative embodiment, (as shown in FIG. 35—an exploded perspective view) planar wick segments 310 may comprise a series of recessed cutaways 362a and 362b removed from respective sections of wick body edge 311a and creased edge 313 and spaced at coinciding intervals. Cutaway 362a may remain shy of cutaway 362b edge (shown in FIG. 36—a perspective cross sectional view) exposing a spacing 363 in part sealed to an opposing and generally coinciding exposed counterpart by an adhesive or crimping process while leaving unsealed entry points 313b.

Planar wick segments 310 may be supported by a floating platform 364 (FIG. 35) comprising a fire bed 364a structure held afloat by an underlying flotation buoy 367. In detail, fire bed 364a embodies a stamped out planar sheet of heat-resistant material of generally uniform cross-sectional thickness, comprising an upper ply 365a, a lower ply 364b and a perimeter edge 364c from which a number of tabs 364d extend in a downwardly bent formation to support the planar sheet surface above flotation buoy 367 (as shown in FIG. 38—a front, cross sectional view) leaving an air gap 370 in between. Buoy 367 may be constructed of a stamped out, porous or low density core body comprising a top and bottom ply 367a and 367b, perforated by an inner hollow core 368 forming an inner perimeter wall 368a and an outer perimeter wall 368b. Materials having low densities for floatation may include, but not be limited to, closed cell foams, balsa wood, cork or synthetic foam amalgamates.

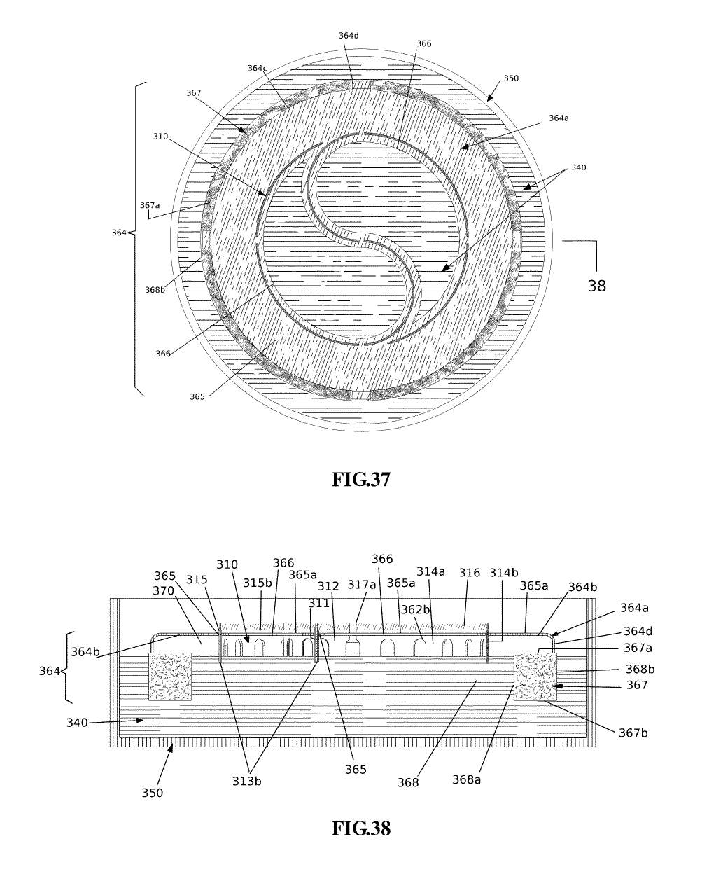

Fire bed 364a (as shown in FIG. 35 and FIG. 37—a top plan view) may have one or more stamped out slits 365, of generally uniform width, piercing through portions of its surface, individually or collectively forming a cut path outline of predefined graphic design.

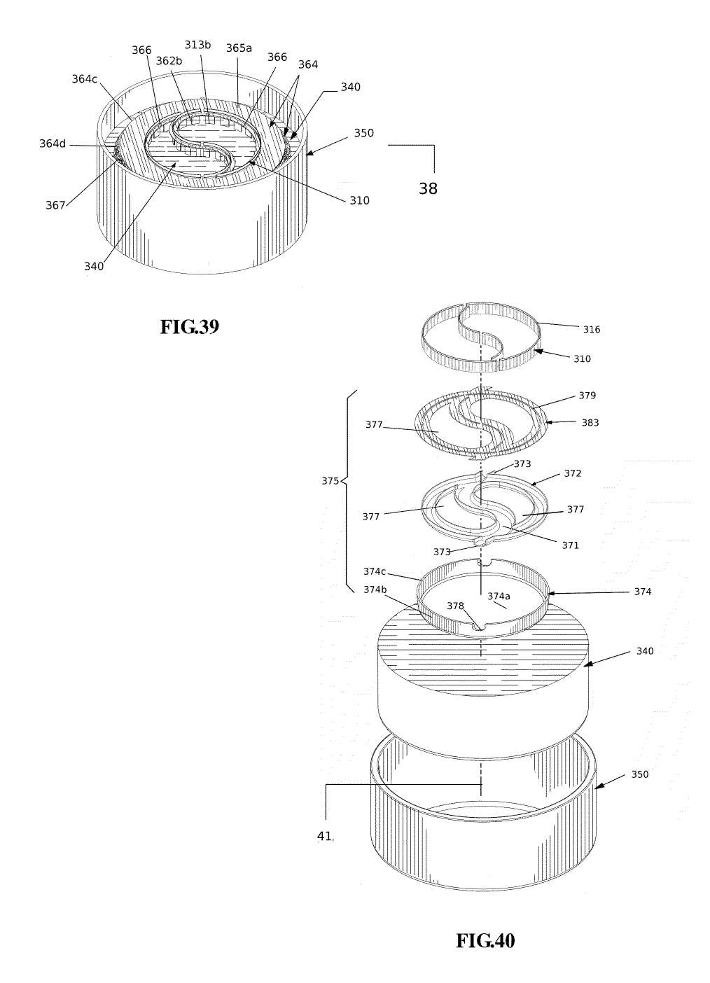

Planar wick segments 310 may be bent and inserted into corresponding slits 365, (as shown in FIG. 39—a perspective view) forming a protruding ignitable wick path of predefined design upon upper ply 365a while having lower edge portions dangle from lower ply 364b (best seen in FIG. 38). Graphic outlines may vary in size, shape, number or location within the fire bed sheet perimeter. Simple patterns may consist of a single line, arch or a even number of semi/fully enclosed shapes otherwise joined together to form combined patterns of higher complexity. Designated surface areas of fire bed 364a surrounded by semi or fully looped wick segment configurations (FIGS. 35 and 39) may further comprise one or more ventilation holes 366 allowing air to flow from areas beneath the fire bed plane into the looped configuration voids. When planar wick segments 310 are lit, a flame forms along ignitable tongue 316 (best seen in FIG. 26) spreading laterally along the wick segment path and onto adjacent path segments, eventually generating a fire-lit graph outline resembling a drawing, spelling of a word or symbol, in fire form. Air flow within an ignited looped or semi-looped path configuration is essential to allow a convection-induced fresh air flow to form within looped arrangements of the resulting flame, preventing an otherwise unwanted “fire coning effect” from taking place within. Ideally, ventilation holes 366 (as shown in FIG. 37) contour the looped arrangement profile to grant the maximum aperture possible.

Upper portions of the fire bed 364a (as shown in FIG. 38) structure are held buoyant upon the fuel surface allowing only the lower-most edge of planar wick segments 310 to dangle from lower ply 364b and remain partially inserted into the underlying combustible fuel surface. In contrast, upper most portions of cutaways 362a and air gap 370 remain emerged from the underlying fuel layer along the segment stretch, to form open passages through which air may travel freely between the outer and inner areas of the graphic layout both above and below the fire bed surface plane.

In an alternative embodiment yet, (as shown in FIG. 40—an exploded perspective view) a floating wick platform 375, may remain buoyant by displacement upon combustible fuel 340 using a cupped basin 374 comprising a base ply 374a surrounded by a basin wall 374b ending in a generally level basin wall edge 374c interrupted at intervals by a number of concave cutaways 378.

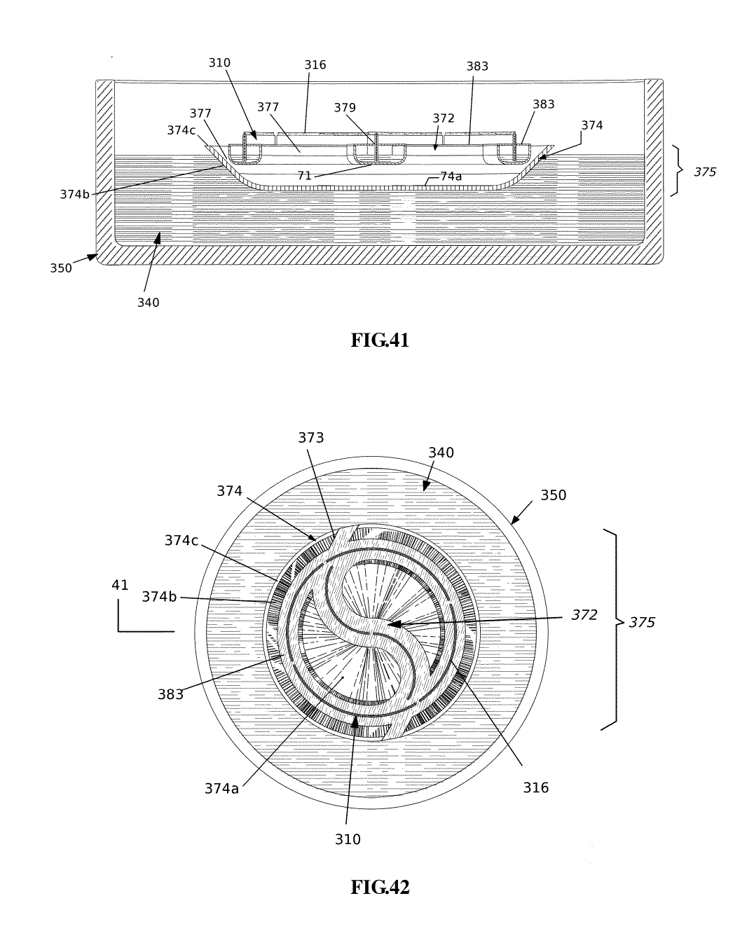

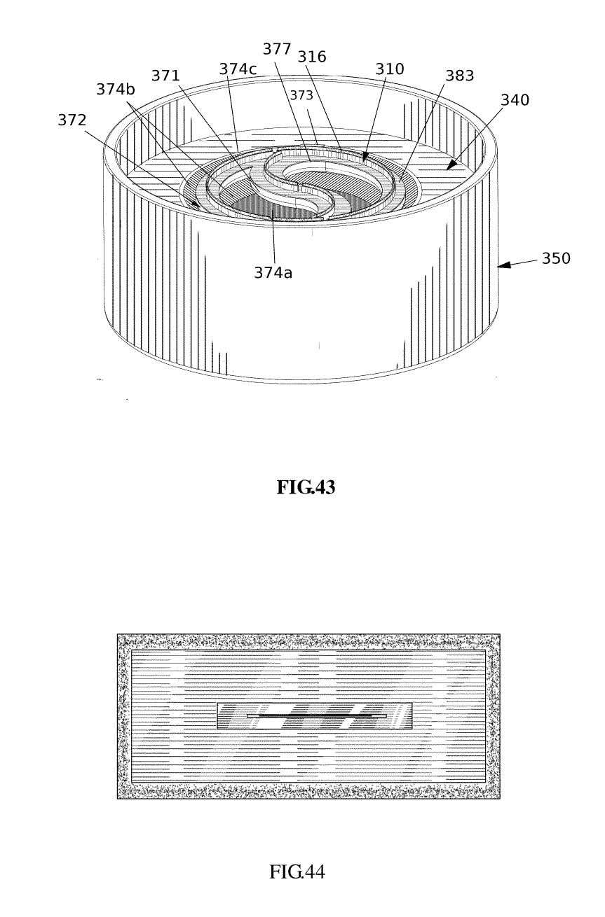

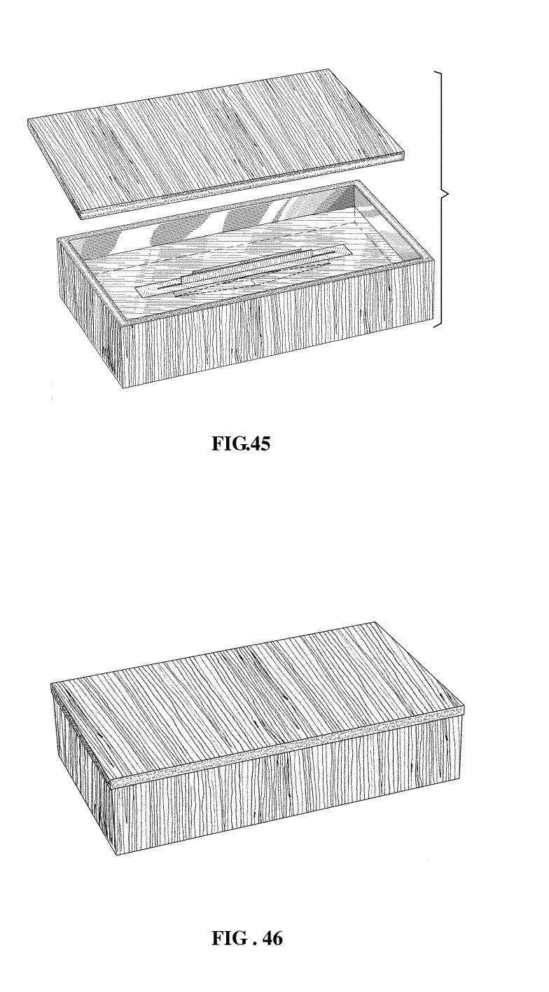

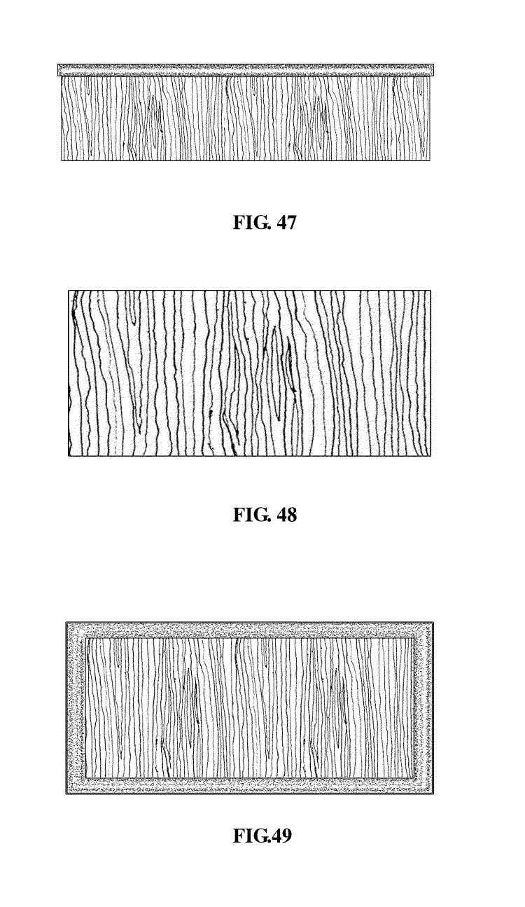

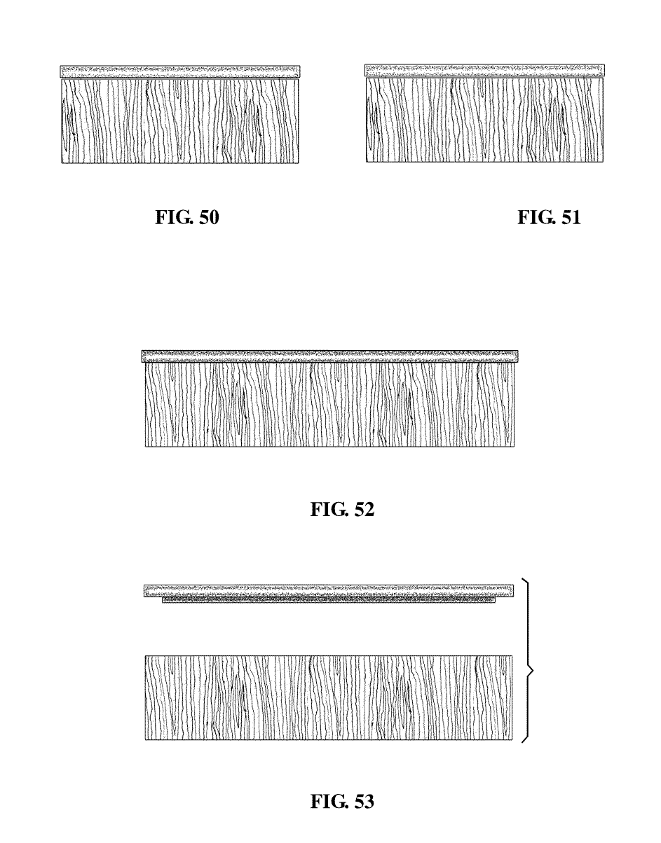

Floating wick platform 375 may also comprise one or more canals 371 of generally concave cross section, independently forming or collectively interconnecting with each other to form a trough outline 372 of predefined design. Trough outline 372 may be suspended and fixed within the basin void by a number of concave fueling ducts 373 connecting sections of the canal outline to cutaways 378 (FIG. 41—a front elevation cross-sectional view) at a level with wall edge 74c.

Intersecting or looped canal paths may form enclosed hollow air ducts 377 (as shown in FIG. 42—a top view) throughout the design and between fueling ducts 373 and basin wall edge 374c, allowing air to pass freely there between.

Floating wick platform 375 (as shown in FIG. 43—a perspective view) may be devised to float just above fuel level partially sinking canals 371 below the fuel level (FIG. 41) forcing surrounding fuel to fill the interconnected canal web, led in through fueling ducts 373. Trough outline 372 (as shown in FIGS. 40 and 41) may further be covered by a safety lid 383 of thin, heat resistant material, cut to fit the canal pattern either resting upon or affixing onto the upper edges 371a of the same at least in part, covering it. Planar wick segments 310 may be cut to length, bent to align with sections of the pattern and finally inserted at intervals into a number of slit perforations 379 piercing through surface portions of safety lid 383, in contoured fashion, eventually forming an ignitable sequence of planar wick segments shaped into the canal outline. As the lowermost edge of planar wick segments 310 (FIG. 41) would remain, at least in part, submerged within the fuel-filled canal outline void, they would be granted a continuous supply of fresh fuel as wick platform 375 remains afloat. Any number of shapes or combination of shapes may be formed in this method. When planar wick segments 310 are lit, the resulting heat generated by the flames generate a vertical convection current drawing air in from the outermost the air ducts 377 closest to basin wall edge 374c, into the basin void and up and through air ducts 377 establishing a convective heat flow balance within the pattern spaces thus preventing a fire coning effect within enclosed or semi enclosed portions of the pattern.

1. An apparatus for generating a two-dimensional graphic image of fire, defined by one or more vector paths of continuous flame, supplied by a common reservoir of fuel, comprising
A container, acting as the base of the apparatus, serving as the reservoir, and forming a housing that encloses the entire apparatus, except its top side,
A combustibly ignitable fuel, conformable to the internal shape of the container reservoir as a fuel volume, so that the upper surface of the fuel volume may be exposed to the atmosphere,
A fire bed, consisting of a panel of fire-resistant material,
covering some or all of the upper surface of the fuel, so that the reservoir and the fire bed can be juxtaposed to substantially cover the fuel volume,
and having one or more perforations arranged as an array vector paths that, together, form a pre-determined image upon the fire bed, wherein the perforations allow the transfer of fuel from the fuel volume below the fire bed, through the perforation vector paths forming the image, and
A three-dimensional array of flammable wicking means, disposed through the perforations in the fire bed,
such that a portion of the wicking means extends below the fire bed, to be immersible in the fuel volume,
and another portion of the wicking means is situated above the fire bed, and exposed to the atmosphere,
in such a way that that, when the exposed portion of the wicking means is set on fire, the resulting flame consumes the fuel, engulfs the exposed portion of wicking means, and takes the appearance of the pre-determined graphic image.

2. The apparatus in claim 1, wherein the fire bed essentially covers the entire upper surface of the fuel.

3. The apparatus in claim 1, wherein the wicking means is a candle-wick string.

4. The apparatus in claim 3, wherein the string is stitched into the fire bed.

5. The apparatus in claim 4, wherein the stitching process of the stitched string is performed in such a way that a portion of each elemental stitch allows the flow of air between the fire bed surface and the portion of elemental stitch.

6. An apparatus for generating a two-dimensional graphic image of fire, defined by one or more vector paths of continuous flame, supplied by a common reservoir of fuel, comprising
A container, acting as the base of the apparatus, serving as the reservoir, and forming a housing that encloses the entire apparatus, except its top side,
A combustibly ignitable fuel, conformable to the internal shape of the container reservoir as a fuel volume, so that the upper surface of the fuel volume may be exposed to the atmosphere,
A fire bed, consisting of a panel of fire-resistant material,
covering the upper surface of the fuel, so that the reservoir and the fire bed can be juxtaposed to substantially cover the fuel volume,
and situating an array of vector paths that, together, form a pre-determined image upon the fire bed, wherein the perforations allow the transfer of fuel from the fuel volume below the fire bed, through the perforation vector paths forming the image; and
A composite wicking structure, comprising a three-dimensional array of flammable wicking means, and a corresponding array of fire-resistant means for structural reinforcement of the wicking means, wherein the composite wicking structure is slideably engaged to the fire bed, through the perforations,
such that a portion of the composite wicking structure extends below the vector bed, to be immersible in the fuel volume,
another portion of the composite wicking structure is situated above the vector bed, and exposed to the atmosphere in the form of an array of vector paths, and
the composite wicking structure is slideably engaged with the fire bed, to allow the height of the exposed composite wicking structure portion to be user-adjustable, and to be given columnar support by the means for structural reinforcement,
in such a way that that, when the exposed portion of the composite wicking structure is set on fire, the resulting flame consumes the fuel, engulfs the exposed portion of wicking means, and takes the appearance of the pre-determined graphic image.

7. The apparatus in claim 6, wherein the fire-resistant panel of the fire bed is united with the container as a single, substantially contiguous housing.

8. The apparatus in claim 7, wherein the housing comprises one or more through-passageways, such that air is allowed to enter the container, and burn with the fuel, along the path of the composite wicking structure.

9. The apparatus in claim 8, wherein the set of one or more through-passageways enters the container at some position below the composite wicking structure.

10. The apparatus in claim 8, wherein the set of one or more through-passageways defines the one or more of the vector paths.

11. The apparatus in claim 10, further comprising a dissociated floating body, wherein the firebed floats on top of a dissociated floating body, without directly attaching to the container.

12. The apparatus in claim 11, wherein the dissociated floating body consists of cork.

13. An apparatus for generating a two-dimensional graphic image of fire, defined by one or more vector paths of continuous flame, supplied by a common reservoir of fuel, comprising
A container, acting as the base of the apparatus, serving as the reservoir, and forming a housing that encloses the entire apparatus, except its top side,
A combustibly ignitable fuel, conformable to the internal shape of the container reservoir as a fuel volume, so that the upper surface of the fuel volume may be exposed to the atmosphere,
A fire bed, consisting of a panel of fire-resistant material,
covering the upper surface of the fuel, so that the reservoir and the fire bed can be juxtaposed to substantially enclose the fuel volume,
and having one or more perforations arranged as an array vector paths that, together, form a pre-determined image upon the fire bed, wherein the perforations allow the transfer of fuel from the fuel volume below the fire bed, through the perforation vector paths forming the image;
A means for spring-loaded vertical support, constructed to withstand slightly less than the weight of the fire bed, and located within the fuel volume below the fire bed, and
A composite wicking structure, comprising a three-dimensional array of flammable wicking means, and a corresponding array of fire-resistant means for structural reinforcement of the wicking means, wherein the composite wicking structure is slideably engaged to the fire bed, through the perforations,
such that a portion of the composite wicking structure extends below the fire bed, to be immersible in the fuel volume,
another portion of the composite wicking structure is situated above the fire bed, and exposed to the atmosphere in the form of an array of vector paths,
the composite wicking structure is slideably engaged with the fire bed, to allow the height of the exposed composite wicking structure portion to be user-adjustable, and to be given columnar support by the means for structural reinforcement, and
the means for spring-loaded vertical support is fixably positioned under the slideably engaged composite wicking structure, and pre-constructed to provide just enough vertical support to withstand the weight of the composite wicking structure, alone, but not enough to withstand the weight of the fire bed,
in such a way that, when the exposed portion of the composite wicking structure is set on fire, the resulting flame consumes the fuel, engulfs the exposed portion of wicking means, and takes the appearance of the pre-determined graphic image, and
in such a way that, while the fuel volume is consumed over time and gradually but continually is reduced in size, the means for spring-loaded support operates to maintain the desired height, for the exposed portion of composite wicking structure.
